(19) United States
(12) Patent Application Publication
(10) Pub. No.: US 2004/0069017 A1
(43) Pub. Date: Apr. 15, 2004

(54) Encapsulation of a display element and method of forming the same

(75) Inventors: Chien-Hsing Li, Taichung City (TW); Chun-Chien Chen, Chu Dung Chen (TW); Jiun-Wei Tsai, Taipei Hsien (TW); Cheng-Nan Yeh, Taoyuan City (TW); Lai-Cheng Chen, Hsingchu (TW)

Correspondence Address: BIRCH STEWART KOLASCH & BIRCH, PO BOX 747, FALLS CHURCH, VA, 22040-0747, US

(73) Assignee: DELTA OPTOELECTRONICS INC.

(21) Appl. No.: 10/679,394

(22) Filed: Oct. 7, 2003

Related U.S. Application Data
(62) Division of application No. 10/028,673, filed on Dec. 28, 2001.

(30) Foreign Application Priority Data
Oct. 9, 2001 (TW) 90124914

(51) Int. Cl. C03C 27/00

(52) U.S. Cl. 65/43; 65/58

(57) ABSTRACT

A display element has a luminescent body formed on a glass substrate, a glass cap with the rim bonded to the rim of the glass substrate, and a sealing layer of frit formed on the bonding region between the glass substrate and the glass cap. In encapsulating, the display element is placed between a pedestal an a pressing plate, and then a high-power laser beam is provided to penetrate the glass cap to focus on the sealing layer, resulting in sintering frit. Also, pressure is applied to the pedestal and the pressing plate.

This application is a Divisional of co-pending application Ser. No. 10/028,673, filed on Dec. 28, 2001, the entire contents of which are hereby incorporated by reference and for which priority is claimed under 35 U.S.C. § 120; and this application claims priority of Application No. 090124914 filed in Taiwan, R.O.C. on Dec. 28, 2001 under 35 U.S.C. § 119.

### BACKGROUND OF THE INVENTION

1. Field of the Invention

The present invention relates to an encapsulation of a display element and a method of forming the same and, more particularly, to an encapsulation of an organic light emitting diode and a method of forming the same.

2. Description of the Related Art

In newer generation display panels, organic light emitting diodes (OLED) or polymer light emitting diodes (PLED) use an electro-luminescence (EL) element, in which electric current applied to specific organic luminescent materials transform electricity into luminosity, thus providing advantages of thin profile, light weight, high luminescent efficiency, and low driving voltage. However, as the duration of use increases, the probability of moisture and oxygen permeating the display element also increases, causing detachment between the metal electrodes and the organic luminescent layer, cracking of the organic materials, and oxidation of the electrodes. As a result, a so-called “dark spot”, to which electricity is not supplied, is generated, decreasing luminescence and luminescent uniformity.

In OLED/PLED processing, after the organic EL element consisting of metal electrodes and organic luminescent films are formed on the glass substrate, a sealing case is commonly used to encapsulate the glass substrate to prevent the internal space of the organic EL element from developing a high humidity condition. Also, various technologies for reducing the interior humidity, to solve the problem of the dark spot, have been developed, such as forming photo-hardened resin on the glass substrate, plating metal oxide, fluoride or sulfide on the glass substrate, forming a water-resistant film on the glass substrate, and using an airtight case to package the organic EL element. Nevertheless, other problems, such as leakage current, crosstalk and oxide dissolution, have yet to be solved.

As shown in FIG. 1, a conventional display element 10 of OLED/PLED comprises a glass substrate 12, a sealing agent 14 of UV-cured resin coated on the rim of the glass substrate 12, and a sealing case 16 bonded to the glass substrate 12 by the sealing agent 14. Thus, an internal space 18 formed by the glass substrate 12 and the sealing case 16 creates an airtight container. Also, in the internal space 18, the glass substrate 12 comprises a lamination body 20 formed by a cathode layer 26, an organic luminescent material layer 24 and an anode layer 22. The sealing agent 14 is UV-cured resin. The sealing case 16 is selected from metal materials or glass materials with a smaller size than the glass substrate to encapsulate the lamination body 20 and only expose predetermined electrodes that is driven by electronic-package circuits. However, the UV-cured resin used in the sealing agent 14 is epoxy resin that has unexpected adhesion for bonding the glass substrate 12 and the sealing case 16, and poor resistance to moisture in the internal space 18 caused by outgassing of the sealing agent 14 and the permeation of water and oxygen from the atmosphere. This may compromise the luminescent properties of the display element 10.

One improved encapsulation for the display element 10 is to provide a sealing agent 28 to fill the internal space 18, as shown in FIG. 1B, thus encapsulating the lamination body 20. The other improved encapsulation for the display element 10 is to provide the sealing agent 28 but omit the fabrication of the sealing agent 14, as shown in FIG. 1C. However, the sealing agent 28 is UV-hardened resin or thermal-hardened resin that contains a large amount of moisture caused by outgassing. The problem of detachment between the metal electrodes and the organic luminescent layer persists.

In addition, glass sealant may be used to encapsulate the display element. Since glass material has excellent airtight performance and an expansion coefficient approximated to the expansion coefficient of the glass substrate, glass sealants, such as frit and solder glass, are conventionally used to encapsulate cathode ray tube (CRT), and plasma display panel (PDP). In encapsulation, sintering in a high-temperature furnace is required for the glass sealant. Even for the glass sealant containing large lead, such as PbO—B₂O₃, however, the sintering temperature is more than the 320° C. that far exceeds the glass translation temperature Tg, approximately 90° C. To solve this problem, partial heating can replace the high-temperature furnace, but the apparatus for partial heating must be carefully chosen to prevent thermal stress.

### SUMMARY OF THE INVENTION

The present invention provides a display element for OLED/PLED with frit as the sealing material to solve the problems caused in the prior art.

The display element has a luminescent body formed on a glass substrate, a glass case with the rim bonded to the rim of the glass substrate, and a sealing layer of frit formed on the bonding region between the glass substrate and the glass cap. In encapsulating, the display element is placed between a pedestal and a pressing plate, and then a high-power laser beam or infrared ray is provided, penetrating the glass cap and focusing on the sealing layer, resulting in sintering frit. Also, pressure is applied to the pedestal and the pressing plate.

Accordingly, it is a principal object of the invention to provide a display element in which the sealing layer has good resistance to permeation of water and oxygen.

It is another object of the invention to make a display element with uniform height gaps at each bonding point between the glass cap and the glass substrate.

Still another object of the invention is to provide an encapsulating method to avoid deformation and fracture of the glass cap and the glass substrate and prevent damage to the luminescent body.

Another object of the invention is to provide an encapsulating method to vertically conduct generated heat outside the display element, thereby maintaining a stable and safe operating temperature.

These and other objects of the present invention will become readily apparent upon further review of the following specification and drawings.

### BRIEF DESCRIPTION OF THE DRAWINGS

FIG. 1 is a sectional diagram showing a conventional display element.

FIG. 2 is a sectional diagram showing an encapsulation of a display element for OLED/OLED according to the first embodiment of the present invention.

FIG. 3 is a sectional diagram showing a method of encapsulating the display element according to the first embodiment of the present invention.

FIG. 4A shows sectional diagrams of an encapsulation of a display element for OLED/PLED according to the second embodiment of the present invention.

FIG. 4B is a top view showing a modified case according to the second embodiment of the present invention.

FIG. 5 is a sectional diagram showing an encapsulation of a display element for OLED/PLED according to the third embodiment of the present invention.

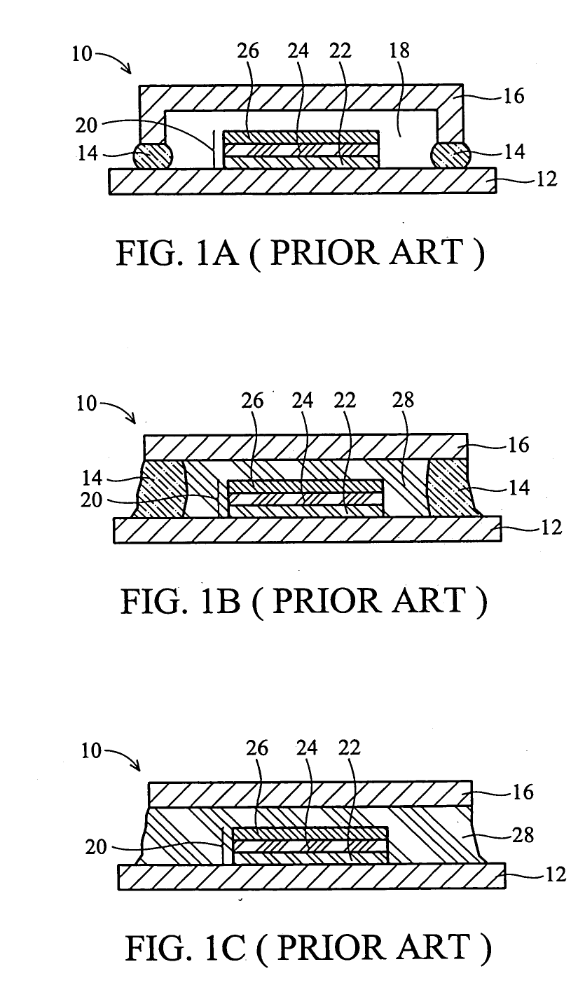

Similar reference characters denote corresponding features consistently throughout the attached drawings.

### DETAILED DESCRIPTION OF THE PREFERRED EMBODIMENTS

[First Embodiment]

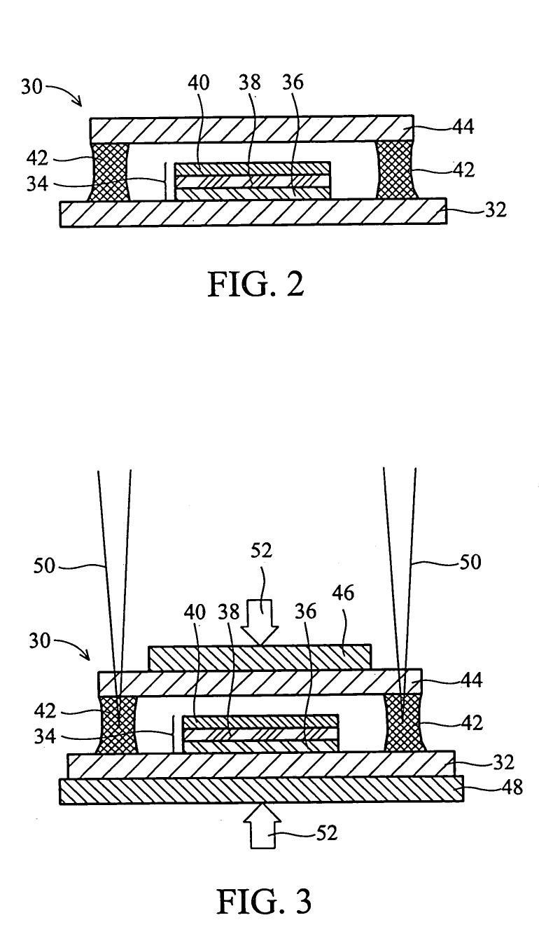

FIG. 2 is a sectional diagram showing an encapsulation of a display element for OLED/OLED according to the first embodiment of the present invention. The display element 30 comprises a glass substrate 30, on which a luminescent body 34 laminated by an anode layer 36, an organic luminescent layer 38 and a cathode layer 40 are all formed. A sealing layer 42 is formed on the rim of the glass substrate 32 by printing or coating to provide adhesion between the rim of the glass substrate 32 and the rim of a glass cap 44. Thus, the internal space formed by bonding the glass cap 44 and the glass substrate 32 creates an airtight container.

The sealing layer 42 is of glass sealant, preferably frit, and contains spacers. The spacers keep each gap between the glass cap 44 and the glass substrate 32 of a uniform height. The frit provides good resistance to both internal moisture and permeation of water and oxygen from the atmosphere. This decreases the environmental limitations of operating the display element 30 of the OLED/PLED, and increases the lifetime of the OLED/PLED.

FIG. 3 is a sectional diagram showing a method of encapsulating the display element 30 according to the first embodiment of the present invention. In sintering the sealing layer 42, a high-power laser beam or infrared ray may be used as the sintering source to provide strong heat within a very small region, thus the temperature at the periphery of the focused region is not high enough to generate thermal stress. In encapsulating the display element 30, the display element 30 is placed between a pressing plate 46 and a pedestal 48, and a high-power beam 50, such as a laser beam or infrared ray, is applied to the glass cap 44 and appropriate pressure 52 is applied to the pressing plate 46 and the pedestal 48. Preferably, metal materials with good thermal conductivity, such as Copper (Cu), are used to form the pressing plate 46 and the pedestal 48. The high-power beam 50 can penetrate transparent glass without being absorbed by indium tin oxide (ITO). Preferably, the high-power beam 50 is a laser beam having a wavelength of more than 550 nm, such as a high-power diode laser of 800 nm wavelength and an Nd-YAG laser of 1064 nm wavelength. Alternatively, the high-power beam 50 is an infrared ray having a wavelength of more than 800 nm.

The high-power beam 50 can penetrate the glass cap 44 to focus on the sealing layer 42 so as to sinter the frit. At the same time, the appropriate pressure 52 applied to the pressing plate 46 and the pedestal 48 reduces the gap between the glass cap 44 and the glass substrate 32 to match the spacers, thus ensuring a uniform gap at each bonding point. Also, the appropriate pressure 52 can absorb the heat generated in sintering the frit at a high temperature. This decreases the temperature difference between the glass cap 44/the glass substrate 32 and the frit to safeguard the glass cap 44/the glass substrate 32 from deformation and fracture and protect the luminescent body 34 from damage. Furthermore, the thermal conductivity of glass materials is far lower than the thermal conductivity of metal materials, and the thickness of the glass cap 44 and the glass substrate 32, only about 0.7 mm, is smaller than the distance between the sealing layer 42 and the luminescent body 34. Therefore, the heat generated in sintering the frit at a high temperature is easily vertically conducted to the pressing plate 46 and the pedestal 48 without damaging the luminescent body 34.

[Second Embodiment]

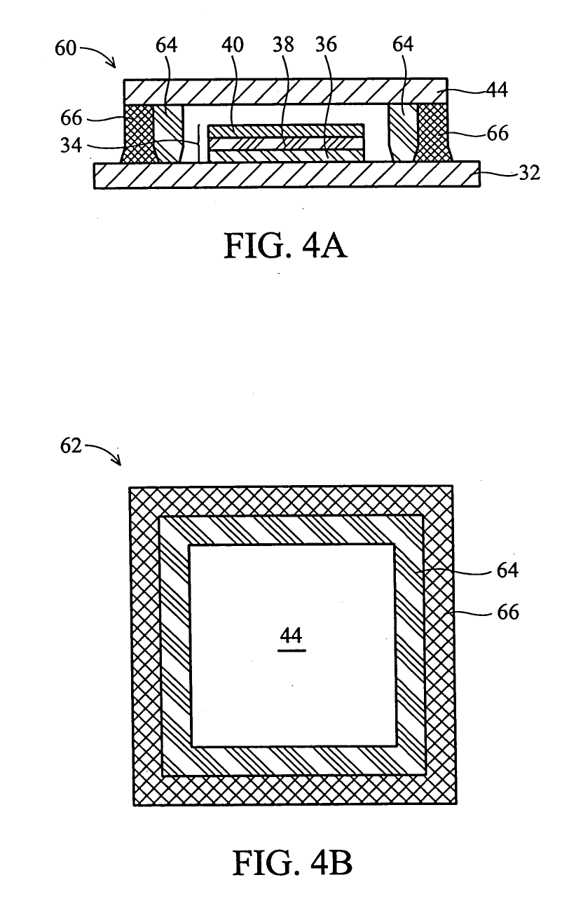

FIG. 4A shows sectional diagrams of an encapsulation of a display element for OLED/PLED according to the second embodiment of the present invention. FIG. 4B is a top view showing a modified case according to the second embodiment of the present invention. In encapsulating a display element 60, a modified case 62 is provided with a rib structure 64 formed on the rim of the glass cap 44, and a glass sealant layer 66 of frit coated on the rim of the glass cap 44 and surrounding the rib structure 64. The rim of the modified case 62 is bonded to the rim of the glass substrate 32 to create an airtight container. The rib structure 64 is frit or ceramic material and formed by well-known sintering techniques on the glass cap 44 prior to the formation of the glass sealant layer 66. The rib structure 64 has the same function with the spacers mixed in the sealing layer 42 of the first embodiment to provide an uniform gap at each bonding point between the glass cap 44 and the glass substrate 32. Also, the rib structure 64 can isolate the radiant heat generated in sintering the glass sealant layer 66 to prevent the luminescent body 34 from burning. Further, the rib structure 64 can stop the frit from flowing into the internal space and preventing the luminescent body 34 from contact with the frit, thus ensuring the luminescent performance of the display element 30. Moreover, the rib structure 64 compensates the glass sealant layer 66 for its insufficient airtight density to improve the resistance to moisture and oxygen.

The method of encapsulating the display element 60 is the same as the method described in the first embodiment. Since spacers are not embedded in the glass sealant layer 66, the laser beam can successively focus on the glass sealant layer 66. Also, the glass sealant layer 66 is opaque, thus stopping the laser beam from penetrating through the glass sealant layer 66 to reach the glass substrate 32.

[Third Embodiment]

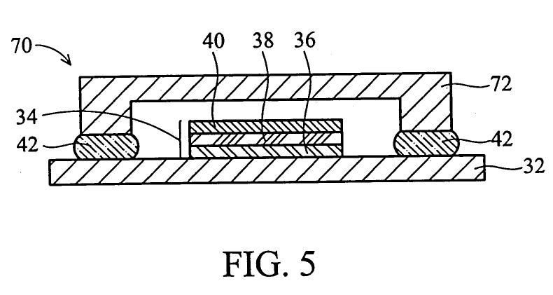

FIG. 5 is a sectional diagram showing an encapsulation of a display element for OLED/PLED according to the third embodiment of the present invention. The other modified case 62 is provided with a concavity formed by sandblasting or etching the glass cap 44 described in the first embodiment. This increases the internal space formed by bonding the modified case 72 and the glass substrate 32 to prevent the luminescent body 34 from being burned by the radiant heat transmitted to the modified case 72. The sealing layer 42 is selected from frit or frit containing spacers. The method of encapsulating the display element 70 is the same as the method described in the first embodiment.

It is to be understood that the present invention is not limited to the embodiments described above, but encompasses any and all embodiments within the scope of the following claims.

What is claimed is:

1. A method of encapsulating a display element, comprising steps of:
providing an organic light emitting diode or a plastic light emitting diode, comprising a luminescent body formed on a glass substrate and a glass cap with a rib structure formed on the bottom surface thereof;
coating a sealing layer of frit on the rim of the glass cap and surrounding the rib structure;
providing a pedestal on which the display element is placed;
providing a pressing plate disposed on the display element;
providing a high-power beam penetrating the glass cap to focus on the sealing layer so as to sinter the frit; and
applying pressure on the pedestal and the pressing plate.

2. The method of encapsulating a display element according to claim 1, wherein the pedestal and the pressing plate are of metal materials with good thermal conductivity.

3. The method of encapsulating a display element according to claim 1, wherein the high-power beam is a laser beam.

4. The method of encapsulating a display element according to claim 1, wherein the laser beam has a wavelength exceeding 550 nm.

5. The method of encapsulating a display element according to claim 1, wherein the high-power beam is an infrared ray.

6. The method of encapsulating a display element according to claim 1, wherein the infrared ray has a wavelength exceeding 800 nm.

7. The method of encapsulating a display element according to claim 1, wherein the rib structure is frit.

8. The method of encapsulating a display element according to claim 1, wherein the rib structure is of ceramic materials.

9. The method of encapsulating a display element according to claim 1, wherein the luminescent body is laminated with at least an anode layer, an organic luminescent layer and a cathode layer.
